(19) United States
(12) Patent Application Publication
(10) Pub. No.: US 2005/0175803 A1
(43) Pub. Date: Aug. 11, 2005

(54) Preparation of polyethylene films

(76) Inventor: D. Ryan Breese, Loveland, OH (US)

Correspondence Address: LYONDELL CHEMICAL COMPANY, 3801 WEST CHESTER PIKE, NEWTOWN SQUARE, PA, 19073, US

(21) Appl. No.: 10/774,161

(22) Filed: Feb. 6, 2004

(51) Int. Cl. B29C 55/00

(52) U.S. Cl. 428/35.7; 264/210.1

(57) ABSTRACT

A method for making high modulus and high density polyethylene films is disclosed. The method comprises orienting in machine direction (MD) a polyethylene blown film to a draw-down ratio greater than 10:1 to produce an MD oriented film having a 1% secant MD modulus of 1,000,000 psi or greater.

### FIELD OF THE INVENTION

The invention relates to polyethylene films. More particularly, the invention relates to polyethylene films which have high density and high modulus.

### BACKGROUND OF THE INVENTION

Polyethylene is divided into high-density (HDPE, density 0.941 g/cc or greater), medium-density (MDPE, density from 0.926 to 0.940 g/cc), low-density (LDPE, density from 0.910 to 0.925 g/cc), and linear low-density polyethylene (LLDPE, density from 0.910 to 0.925 g/cc). See ASTM D4976-98: Standard Specification for Polyethylene Plastic Molding and Extrusion Materials. Polyethylene can also be divided by molecular weight. For instance, ultra-high molecular weight polyethylene denotes those which have a weight average molecular weight (Mw) greater than 3,000,000. See U.S. Pat. No. 6,265,504. High molecular weight polyethylene usually denotes those which have an Mw from 130,000 to 1,000,000.

One of the main uses of polyethylene (HDPE, LLDPE, and LDPE) is in film applications, such as grocery sacks, institutional and consumer can liners, merchandise bags, shipping sacks, food packaging films, multi-wall bag liners, produce bags, deli wraps, stretch wraps, and shrink wraps. The key physical properties of polyethylene film include tear strength, impact strength, tensile strength, stiffness and transparency. Film stiffness can be measured by modulus. Modulus is the resistance of the film to deformation under stress.

While there are few polyethylene films of modulus greater than 100,000 psi, there is an increasing demand for such films. For example, the stand-up pouch has been the fastest growing segment of the flexible packaging industry over the past several years. Such pouches are used to package a wide variety of goods, including foods, industrial, and agricultural products. One of the key benefits of the stand-up pouch is its physical shape which gives the package a unique “billboard” effect. Such a design presents the packager with additional exposed area for high quality graphics that can be used to entice the consumer to purchase the good. Another benefit of the stand-up pouch is the uniqueness in its shape, allowing the packager to differentiate their products from their competitors. Polymer films of high stiffness values are necessary to achieve both of these characteristics unique to the stand-up pouch. A further enhancement in stiffness over the incumbent polymer films would allow the packager to produce stand-up pouches in larger sizes, thinner packages, and/or more unique and creative shapes. Such innovations are desirable to all in the stand-up pouch industry for creating new products that are visually appealing to the consumer.

Machine direction orientation (MDO) is known to the polyolefin industry. When a polymer is strained under uniaxial stress, the orientation becomes aligned in the direction of pull. For instance, U.S. Pat. No. 6,391,411 teaches the MDO of high molecular weight (both Mn and Mw greater than 1,000,000) HDPE films. However, high molecular weight HDPE films are usually by cast film processes, which are more costly than blown film processes. Further, MDO of high molecular weight HDPE films are limited because these films are difficult to stretch to a high draw-down ratio.

It would be desirable to prepare a polyethylene film which has a modulus greater than 1,000,000 psi. Ideally, the high modulus films would be made by the MD orientation of high molecular weight HDPE blown films.

### SUMMARY OF THE INVENTION

The invention is a method for preparing a high modulus, high density polyethylene (HDPE) film. The method comprises orienting in the machine direction (MD) an HDPE blown film to a draw-down ratio greater than 10:1. The MD oriented film having an MD 1% secant modulus of 1,000,000 psi or greater. Preferably, the MD 1% secant modulus is 1,100,000 psi or greater. Preferably, the HDPE has a density within the range of 0.950 to 0.970 g/cc, a weight average molecular weight (Mw) within the range of 130,000 to 1,000,000, and a number average molecular weight (Mn) within the range of 10,000 to 500,000.

### DETAILED DESCRIPTION OF THE INVENTION

The invention is a method for preparing a high modulus, high density polyethylene (HDPE) film. Polyethylene resin suitable for making the film of the invention has a density within the range of about 0.950 to about 0.970 g/cc. Preferably, the density is within the range of about 0.955 to about 0.965 g/cc. More preferably, the density is within the range of 0.958 to 0.962 g/cc.

Preferably, the polyethylene resin has a number average molecular weight (Mn) within the range of about 10,000 to about 500,000, more preferably from about 11,000 to about 50,000, and most preferably from about 11,000 to about 20,000. Preferably, the polyethylene resin has a weight average molecular weight (Mw) within the range of about 130,000 to about 1,000,000, more preferably from about 150,000 to about 500,000, and most preferably from about 155,000 to about 250,000. Preferably, the polyethylene resin has a molecular weight distribution (Mw/Mn) within the range of about 5 to about 20, more preferably from about 7 to about 18, and most preferably from about 9 to about 17.

The Mw, Mn and Mw/Mn are obtained by gel permeation chromatography (GPC) on a Waters GPC2000CV high temperature instrument equipped with a mixed bed GPC column (Polymer Labs mixed B-LS) and 1,2,4-trichlorobenzene (TCB) as the mobile phase. The mobile phase is used at a nominal flow rate of 1.0 mL/min and a temperature of 145° C. No antioxidant is added to the mobile phase, but 800 ppm BHT is added to the solvent used for sample dissolution. Polymer samples are heated at 175° C. for two hours with gentle agitation every 30 minutes. Injection volume is 100 microliters.

The Mw and Mn are calculated using the cumulative matching % calibration procedure employed by the Waters Millenium 4.0 software. This involves first generating a calibration curve using narrow polystyrene standards (PSS, products of Waters Corporation), then developing a polyethylene calibration by the Universal Calibration procedure.

Preferably, the polyethylene resin has a melt index MI₂ from about 0.03 to about 0.15 dg/min, more preferably from about 0.04 to about 0.15 dg/min, and most preferably from 0.05 to 0.10. The MI₂ is measured at 190° C. under 2.16 kg of pressure according to ASTM D-1238. In general, the higher the molecular weights, the lower the MI₂ values.

Preferably, the polyethylene resin is a copolymer that comprises from about 90 wt % to about 98 wt % of recurring units of ethylene and from about 2 wt % to about 10 wt % of recurring units of a C₃ to C₁₀ α-olefin. Suitable C₃ to C₁₀ α-olefins include propylene, 1-butene, 1-pentene, 1-hexene, 4-methyl-1-pentene, and 1-octene, and the like, and mixtures thereof.

Suitable polyethylene resins can be produced by Ziegler catalysts or newly developed single-site catalysts. Ziegler catalysts are well known. Examples of suitable Ziegler catalysts include titanium halides, titanium alkoxides, vanadium halides, and mixtures thereof. Ziegler catalysts are used with cocatalysts such as alkyl aluminum compounds.

Single-site catalysts can be divided into metallocene and non-metallocene. Metallocene single-site catalysts are transition metal compounds that contain cyclopentadienyl (Cp) or Cp derivative ligands. For example, U.S. Pat. No. 4,542,199, the teachings of which are incorporated herein by reference, teaches metallocene catalysts. Non-metallocene single-site catalysts contain ligands other than Cp but have the same catalytic characteristics as metallocenes. The non-metallocene single-site catalysts may contain heteroatomic ligands, e.g., boraaryl, pyrrolyl, azaborolinyl or quinolinyl. For example, U.S. Pat. Nos. 6,034,027, 5,539,124, 5,756,611, and 5,637,660, the teachings of which are incorporated herein by reference, teach non-metallocene catalysts.

The polyethylene is converted into a thick film by a high-stalk or in-pocket blown extrusion process. Both high-stalk and in-pocket processes are commonly used for making polyethylene films. The difference between the high-stalk process and the in-pocket process is that in the high-stalk process, the extruded tube is inflated a distance (i.e., the length of the stalk) from the extrusion die, while the extruded tube in the in-pocket process is inflated as the tube exits the extrusion die.

For instance, U.S. Pat. No. 4,606,879, the teachings of which are herein incorporated by reference, teaches high-stalk blown film extrusion apparatus and method. The process temperature is preferably within the range of about 150° C. to about 210° C. The thickness of the film is preferably within the range of about 3 to about 14 mils, more preferably within the range of about 6 to about 8 mils.

The blown film is then uniaxially stretched in the machine (or processing) direction to a thinner film. The ratio of the film thickness before and after orientation is called “draw-down ratio.” For example, when a 6-mil film is stretched to 0.6-mil, the draw-down ratio is 10:1. The draw-down ratio of the method of the invention is greater than 10:1. Preferably, the draw-down ratio is 11:1 or greater. Preferably, the draw-down ratio is such that the film is at or near maximum extension. Maximum extension is the draw-down film thickness at which the film cannot be drawn further without breaking. The film is said to be at maximum extension when machine direction (MD) tensile strength has a less than 100% elongation at break under ASTM D-882.

During the MDO, the film from the blown-film line is heated to an orientation temperature. Preferably, the orientation temperature is between 60% of the difference between the glass transition temperature (Tg) and the melting point (Tm) and the melting temperature (Tm). For instance, if the blend has a Tg of 25° C. and a Tm of 125° C., the orientation temperature is preferably within the range of about 60° C. to about 125° C. The heating is preferably performed utilizing multiple heating rollers.

Next, the heated film is fed into a slow draw roll with a nip roller, which has the same rolling speed as the heating rollers. The film then enters a fast draw roll. The fast draw roll has a speed that is 2 to 10 times faster than the slow draw roll, which effectively stretches the film on a continuous basis.

The stretched film then enters annealing thermal rollers, which allow stress relaxation by holding the film at an elevated temperature for a period of time. The annealing temperature is preferably within the range of about 100° C. to about 125° C. and the annealing time is within the range of about 1 to about 2 seconds. Finally, the film is cooled through cooling rollers to an ambient temperature.

The invention includes the MD oriented film made by the method. The MD oriented film has a 1% secant MD modulus greater than 1,000,000 psi. Modulus is tested according to ASTM E-111-97. Preferably, the MD modulus is greater than 1,100,000 psi.

Besides the high MD modulus, the oriented film remains high at other physical properties. Preferably, the oriented film has an MD tensile strength at yield greater than or equal to 7,000 psi, MD elongation at yield greater than or equal to 3%, MD tensile strength at break greater than or equal to 30,000 psi, and MD elongation at break greater than or equal to 40%. Preferably, the oriented film has 1% secant TD (transverse direction) modulus greater than or equal to 300,000 psi and more preferably 350,000 psi, TD tensile strength at yield greater than or equal to 4,000 psi, TD elongation at yield greater than or equal to 4%, TD tensile strength at break greater than or equal to 4,000 psi, and TD elongation at break greater than or equal to 700%. Tensile strength is tested according to ASTM D-882.

Modulus is tested according to ASTM E-111-97.

Preferably, the MD oriented film has a haze less than 50%. The haze is tested according to ASTM D1003-92: Standard Test Method for Haze and Luminous Transmittance of Transparent Plastics, October 1992. Preferably, the MD oriented film has a gloss greater than 20. The gloss is tested according to ASTM D2457-90: Standard Test Method for Specular Gloss of Plastic Films and Solid Plastics.

The following examples merely illustrate the invention. Those skilled in the art will recognize many variations that are within the spirit of the invention and scope of the claims.

### EXAMPLES 1-6

### Machine Direction Orientation of High Density (0.959 g/cc) High-Stalk Blown Films

A high density polyethylene (L5906, product of Equistar Chemicals, LP, MI₂: 0.057 dg/min, density: 0.959 g/cc, Mn: 13,000, Mw: 207,000, and Mw/Mn: 16) is converted into films with a thickness of 6.0 mil on 200 mm die with 2 mm die gap. The films are produced at a stalk height of 8 die diameters and at blown-up ratios (BUR) of 4:1.

The films are then stretched into thinner films in the machine direction with draw-down ratios 1, 2, 3, 4, 5, 6, 7, 8, 9, 10, and 11.6 in Examples 1-11, respectively. When the draw-down ratio is 1:1, the film is not oriented. The draw-down ratio of 11.6:1 is the maximum draw-down ratio limited by the ientation equipment and not the polymer film. The film properties are ted in Table 1.

TABLE 1
Properties vs. Draw-down Ratio of Machine
Direction Oriented, High-stalk Blown Films

| | | | | MD | TD | MD | TD | | |
|---|---|---|---|---|---|---|---|---|---|
| | | | | Tensile | Tensile | Tensile | Tensile | | |
| | Draw- | MD | TD | Elongation | Elongation | Strength | Strength | | |
| Ex. | Down | Modulus | Modulus | @ Break | @ Break | @ Break | @ Break | | Haze |
| No. | Ratio | psi | psi | % | % | psi | psi | Gloss | % |
| 1 | 1:1 | 188,600 | 196,200 | 470 | 651 | 5,500 | 5088 | 3.5 | 99 |
| 2 | 2:1 | 224,500 | 248,600 | 310 | 677 | 10,900 | 4919 | 3.5 | 90 |
| 3 | 3:1 | 267,300 | 279,300 | 200 | 661 | 14,900 | 4712 | 6.6 | 80 |
| 4 | 4:1 | 318,200 | 301,000 | 130 | 614 | 19,300 | 4484 | 12 | 69 |
| 5 | 5:1 | 378,800 | 317,900 | 88 | 546 | 25,200 | 4252 | 17 | 57 |
| 6 | 6:1 | 451,000 | 331,700 | 58 | 464 | 33,100 | 4,000 | 23 | 47 |
| 7 | 7:1 | 537,000 | 343,300 | 38 | 380 | 42,700 | 3,800 | 28 | 38 |
| 8 | 8:1 | 639,200 | 353,400 | 25 | 303 | 52,600 | 3,700 | 31 | 31 |
| 9 | 9:1 | 761,000 | 362,300 | 16 | 242 | 61,200 | 3,600 | 33 | 28 |
| 10 | 10:1 | 906,000 | 370,200 | 11 | 206 | 65,600 | 3,700 | 33 | 28 |
| 11 | 11.6:1 | 1,197,600 | 381,500 | 5.5 | 227 | 55,263 | 3,900 | 28 | 40 |

### EXAMPLES 12-22

### Machine Direction Orientation of High Density (0.959 g/cc) In-Pocket Blown Films

Examples 1-11 are repeated, but the films are made at in-pocket film line. The film properties are listed in Table 2, which shows that the machine direction oriented, in-pocket films have similar MD and TD Moduli as the high stalk films at their respective maximum draw ratios. The draw-down ratio of 11.3:1 is the maximum draw-down ratio, which is limited by the orientation equipment and not the polymer film.

TABLE 2
Properties vs. Draw-down Ratio of Machine
Direction Oriented, In-pocket Blown Films

| | | | | MD | TD | MD | TD | | |
|---|---|---|---|---|---|---|---|---|---|
| | | | | Tensile | Tensile | Tensile | Tensile | | |
| | Draw- | MD | TD | Elongation | Elongation | Strength | Strength | | |
| Ex. | Down | Modulus | Modulus | @ Break | @ Break | @ Break | @ Break | | Haze |
| No. | Ratio | psi | psi | % | % | psi | psi | Gloss | % |
| 12 | 1:1 | 189,000 | 222,800 | 640 | 750 | 6,200 | 5,300 | 3.6 | 97 |
| 13 | 2:1 | 225,100 | 262,600 | 290 | 600 | 11,100 | 5,100 | 2.6 | 88 |
| 14 | 3:1 | 268,200 | 285,900 | 120 | 630 | 16,100 | 4,900 | 5.7 | 78 |
| 15 | 4.1 | 319,500 | 302,400 | 53 | 660 | 21,100 | 4,600 | 11 | 68 |
| 16 | 5:1 | 380,700 | 315,300 | 39 | 610 | 26,100 | 4,400 | 16 | 59 |
| 17 | 6:1 | 453,600 | 325,700 | 40 | 530 | 31,100 | 4,200 | 21 | 51 |
| 18 | 7:1 | 540,300 | 334,600 | 38 | 470 | 36,100 | 3,900 | 24 | 45 |
| 19 | 8:1 | 643,700 | 342,300 | 29 | 570 | 41,000 | 3,700 | 24 | 41 |
| 20 | 9:1 | 767,000 | 349,000 | 28 | 610 | 46,000 | 3,500 | 24 | 41 |
| 21 | 10:1 | 913,700 | 355,100 | 19 | 550 | 51,000 | 3,200 | 22 | 45 |
| 22 | 11.3:1 | 1,147,300 | 362,100 | 19 | 500 | 57,500 | 2,900 | 20 | 56 |

### COMPARATIVE EXAMPLES 23-30

### Machine Direction Orientation of Polyethylen Blown Films of Various Densities

Three Equistar high density polyethylene resins, XL3805 (density: 0.940 g/cc, MI₂: 0.057 dg/min, Mn: 18,000, Mw: 209,000), XL3810 (density: 0.940 g/cc, MI₂: 0.12 dg/min, Mn: 16,000, Mw: 175,000), L4907 (density: 0.949 g/cc, MI₂: 0.075 dg/min, Mn: 14,000, Mw: 195,000), and L5005 (density: 0.949 g/cc, MI₂: 0.057 dg/min, Mn: 13,000, Mw: 212,000) are converted into films of thickness of 6.0 mil by the high stalk process described in Examples 1-11 and the in-pocket process described in Examples 12-22. The films are then stretched in the machine direction to their maximum draw-down ratios. Listed in Table 3 are the MD and TD moduli of each oriented film at their maximum draw-down ratios. The table shows that these films have low MD and TD moduli.

TABLE 3
MD and TD Moduli vs. Density and Molecular Weight
At Maximum Draw-down Ratios

| | | | | | | MDO | 1% Secant | 1% Secant |
|---|---|---|---|---|---|---|---|---|
| | | | | | | Maximum | MD | TD |
| Ex. | Density | Mw × | Mn × | MI₂ | Film | Draw-Down | Modulus | Modulus |
| No. | g/cc | 10⁻³ | 10⁻³ | dg/min | Process | Ratio | psi | psi |
| 11 | 0.959 | 207 | 13 | 0.057 | High-stalk | 11.6:1 | 1,197,600 | 381,500 |
| 22 | 0.959 | 207 | 13 | 0.057 | In-pocket | 11.3:1 | 1,147,300 | 362,100 |
| C23 | 0.940 | 209 | 18 | 0.057 | High-stalk | 8.3:1 | 352,900 | 227,000 |
| C24 | 0.940 | 209 | 18 | 0.057 | In-pocket | 7.6:1 | 337,800 | 223,100 |
| C25 | 0.940 | 175 | 16 | 0.12 | High-stalk | 6.5:1 | 235,100 | 212,600 |
| C26 | 0.940 | 175 | 16 | 0.12 | In-pocket | 2.2:1 | 114,600 | 142,700 |
| C27 | 0.949 | 195 | 14 | 0.075 | High-stalk | 11.9:1 | 617,000 | 286,400 |
| C28 | 0.949 | 195 | 14 | 0.075 | In-pocket | 7.7:1 | 514,900 | 307,200 |
| C29 | 0.949 | 212 | 13 | 0.057 | High-stalk | 10.6:1 | 514,300 | 275,600 |
| C30 | 0.949 | 212 | 13 | 0.057 | In-pocket | 10.0:1 | 737,200 | 312,600 |

1. A method comprising orienting in the machine direction (MD) a polyethylene blown film to a draw-down ratio greater than 10:1 to produce an MD oriented film having a 1% secant MD modulus of 1,000,000 psi or greater.

2. The method of claim 1 wherein the MD oriented film has a 1% secant transverse-direction (TD) modulus of 300,000 psi or greater.

3. The method of claim 1 wherein the blown film is made from a polyethylene resin which has a density within the range of 0.950 to 0.970 g/cc.

4. The method of claim 1 wherein the blown film is made from a polyethylene resin which has a density within the range of 0.955 to 0.965 g/cc.

5. The method of claim 1 wherein the blown film is made from a polyethylene resin which has a density within the range of 0.958 to 0.962 g/cc.

6. The method of claim 1 wherein the blown film is made from a polyethylene resin which has a weight average molecular weight (Mw) within the range of 130,000 to 1,000,000.

7. The method of claim 6 wherein the Mw is within the range of 150,000 to 500,000.

8. The method of claim 6 wherein the Mw is within the range of 155,000 to 300,000.

9. The method of claim 6 wherein the Mw is within the range of 155,000 to 250,000.

10. The method of claim 1 wherein the blown film is made from a polyethylene resin which has a number average molecular weight (Mn) within the range of 10,000 to 500,000.

11. The method of claim 10 wherein the Mn is within the range of 11,000 to 100,000.

12. The method of claim 10 wherein the Mn is within the range of 11,000 to 50,000.

13. The method of claim 10 wherein the Mn is within the range of 11,000 to 20,000.

14. The method of claim 1 wherein the draw-down ratio is 11:1 or greater.

15. The method of claim 1 wherein the oriented film having a 1% secant MD modulus of 1,100,000 psi or greater

16. An MD oriented polyethylene film made by the method of claim 1.

17. An MD oriented polyethylene film made by the method of claim 5.

18. An MD oriented polyethylene film made by the method of claim 9.

19. An MD oriented polyethylene film made by the method of claim 13.
